(19) United States
(12) Patent Application Publication
(10) Pub. No.: US 2010/0177661 A1
(43) Pub. Date: Jul. 15, 2010

(54) SYSTEM AND METHOD FOR DYNAMIC CREATION OF ROLE BASED TALK GROUPS

(76) Inventor: Timothy Eugene Dailey, Forest, VA (US)

Correspondence Address: HARRIS CORPORATION;C/O FOX ROTHSCHILD, LLP, 997 Lenox Drive, Building 3, Lawrenceville, NJ, 08543-5231, US

(21) Appl. No.: 12/351,647

(22) Filed: Jan. 9, 2009

(51) Int. Cl. H04B 7/00; H04L 12/28

(52) U.S. Cl. 370/254; 455/518

(57) ABSTRACT

A system and method for dynamic creation of role based call groups are provided. The method includes associating attributes with a plurality of radio units and defining a communication group based on the attributes. The communication group has a plurality of required attributes establishing minimum criteria for the communication group. The method further includes dynamically maintaining the communication group with radio units that satisfy the required attributes.

### BACKGROUND OF THE INVENTION

This invention relates generally to wireless communication systems, and more particularly, to systems and methods for defining talk groups within wireless communication systems.

Wireless communication systems may provide communication between individual users and/or between groups of users, such as in a trunked radio system. Group based communications may be provided in public safety or professional communication systems, as well as others. For example, radio frequency communication between land mobile radios (LMRs) may allow messages to be communicated between two users or between a group of users. In particular, these systems may be designed to support Push-To-Talk (PTT) services, such as a dispatch mode of operation, wherein a dispatcher from a central location communicates with one or more radio units or multiple radio units inter-communicate, such as a work group performing a job or project or emergency personnel responding to an emergency at a building. As an example, workers on a job site or emergency rescue personnel, such as firemen, policemen, and paramedics at a scene may use mobile radio systems when communicating. Depending on the circumstance, job or incident different types of individuals (e.g., different workers or emergency personnel) communicate using a single channel defining a communication or call group.

It is known to define communication groups fairly statically. For example, groups are defined in the system and assigned identification (ID) numbers. Thereafter, each radio that needs to participate in the group must be programmed with all the groups in which that radio (or user) might be included. Accordingly, call groups are defined in a fairly static manner because adding a new group requires all applicable radios to be reprogrammed with the new group information. Thus, additional time and effort is needed, for example, in the planning stages by administrators to determine and anticipate every group that might be needed. Further, a large number of defined groups results, which can confuse a user of the radio or complicate the process of selecting groups as the group list for selection may be very long and not well organized.

Moreover, when groups are defined in this static matter, users are also often forced to listen to many communications and then filter out the information that user needs or is important to that user. Thus, communications are heard by a large number of users (many of which may not be needed for that group call) and the user makes the decision as to whether the user should maintain the communication. Excessive “chatter” or communications also may result, which can lead to a user missing important information. Further, this excess communication consumes system resources.

It is also known to dynamically create group addresses for defining talk groups. The dynamic creation is initiated by the end user (e.g., radio user). Accordingly, there is no way to centrally control these groups or centrally administer these groups. Accordingly, for certain applications, these known systems that dynamically create group addresses are not practical or useful. Moreover, a user has to wait for others to subscribe to the group, such as by indicating a similar preference before additional users are added to the group. Accordingly, for situations when certain users are urgently or immediately needed or required as part of the group call, these known systems will not work.

In systems that do not support multicast communications such that group calls are accomplished by transmitting a number of calls to each individual, bandwidth also can be wasted using these known systems. For example, by placing calls to users who do not need to receive the calls, but are receiving the calls as described above, bandwidth is being unnecessarily used.

### BRIEF DESCRIPTION OF THE INVENTION

In accordance with an embodiment, a method for creating a communication group for wireless communication is provided. The method includes associating attributes with a plurality of radio units and defining a communication group based on the attributes. The communication group has a plurality of required attributes establishing minimum criteria for the communication group. The method further includes dynamically maintaining the communication group with radio units that satisfy the required attributes.

In accordance with another embodiment, a method for dynamically creating a communication group is provided. The method includes accessing a central database having stored therein attributes associated with a plurality of radio units and determining rules for a communication group. The method further includes identifying radio units with attributes that satisfy the rules for the communication group and adding the identified radio units to the communication group, with the added radio units connected to a group call.

In accordance with yet another embodiment, a communication system is provided that includes a plurality of radio units configured to communicate via group calls and a database storing attributes associated with each of the plurality of radio units. The communication system further includes a processor configured to process rules to determine a set of attributes for a communication group and a controller configured to dynamically maintain the communication group to include radio units from the plurality of radio units that satisfy a minimum set of attributes.

### BRIEF DESCRIPTION OF THE DRAWINGS

FIG. 1 is a block diagram of a wireless communication system in connection with which various embodiments of the invention may be implemented.

FIG. 2 is a diagram illustrating group radio communications in accordance with various embodiments of the invention.

FIG. 3 is a diagram illustrating attributes associated with radio units stored in memory in accordance with various embodiments of the invention.

FIG. 4 is a diagram illustrating rules defining attributes for groups stored in memory in accordance with various embodiments of the invention.

FIG. 5 is a flowchart illustrating a method of dynamically creating talk groups or workgroups in accordance with various embodiments of the invention.

FIG. 6 is an interface formed in accordance with various embodiments of the invention.

FIG. 7 is another interface formed in accordance with various embodiments of the invention.

FIG. 8 is a diagram illustrating communications using radio units in and at a building that have been dynamically added to a group in accordance with various embodiments of the invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments of the invention provide a system and method for dynamically creating or generating communication groups, such as talk groups (or workgroups) based on roles or rules. Each radio has one or more attributes (or credentials) associated therewith, which may be stored in the radio unit or a central database with an associated user ID. The attribute(s) or credential(s) identifies the roles that the user of the radio unit can fulfill, for example, by satisfying certain system rules, which may include required or optional members (users) for a communication group. During radio use, and based on, for example, trigger points, such as logging in or out, or changing state or location, the system dynamically includes (e.g., dynamically updates) radios in groups based on the attributes or credentials associated with the radios and the current system rules. It should be noted that the various embodiments are not limited to particular triggers, but different triggering events may be used to add a radio to or remove a radio from a communication group. For example, assignment of radios to a communication group, such as a talk group or workgroup may be based on establishing an electronic work ticket (the triggering event).

Accordingly, the various embodiments provide dynamic creation of role based groups that simplifies group administration, reduces bandwidth consumed in group calls and increases the flexibility and features of group communications.

The various embodiments may be implemented in connection with any type of communication system wherein groups of users are defined, such as a wireless communication system, a wired communication system, an Internet based communication system or any combination thereof. The wireless communication system may be one that allows multicast or single stream communications. For example, the various embodiments may be implemented in connection with radios within a public safety or professional communication system or cellular telephones in a commercial communication system. Accordingly, although the various embodiments may be described in connection with a particular wireless communication system, radio unit, or communication protocol, the various embodiments may be implemented in connection with different radio units communicating using different systems or protocols, whether wireless or wired. For example, the radio unit may be any kind of radio capable of transmitting wirelessly, for example, transmitting over the Public Safety Frequency Bands within the VHF, UHF, 700 MHz, 800 MHz and 900 MHz frequencies. Additionally, different communication protocols may be used, for example, one of a Project 25 (TIA 102) or an ETSI TETRA standard, Global System for Mobile Communication (GSM) standard, Enhanced Data rates for GSM Evolution (EDGE) standard, Enhanced GPRS (EGPRS) standard, IMT Single Carrier (IMT-SC) standard or a proprietary format such as an OpenSky M/A-COM proprietary format, a NetworkFirst or EDACS system proprietary format, among others. The various embodiments also may be implemented in connection with clients operating on computer systems that connect to Internet based communication systems as are known.

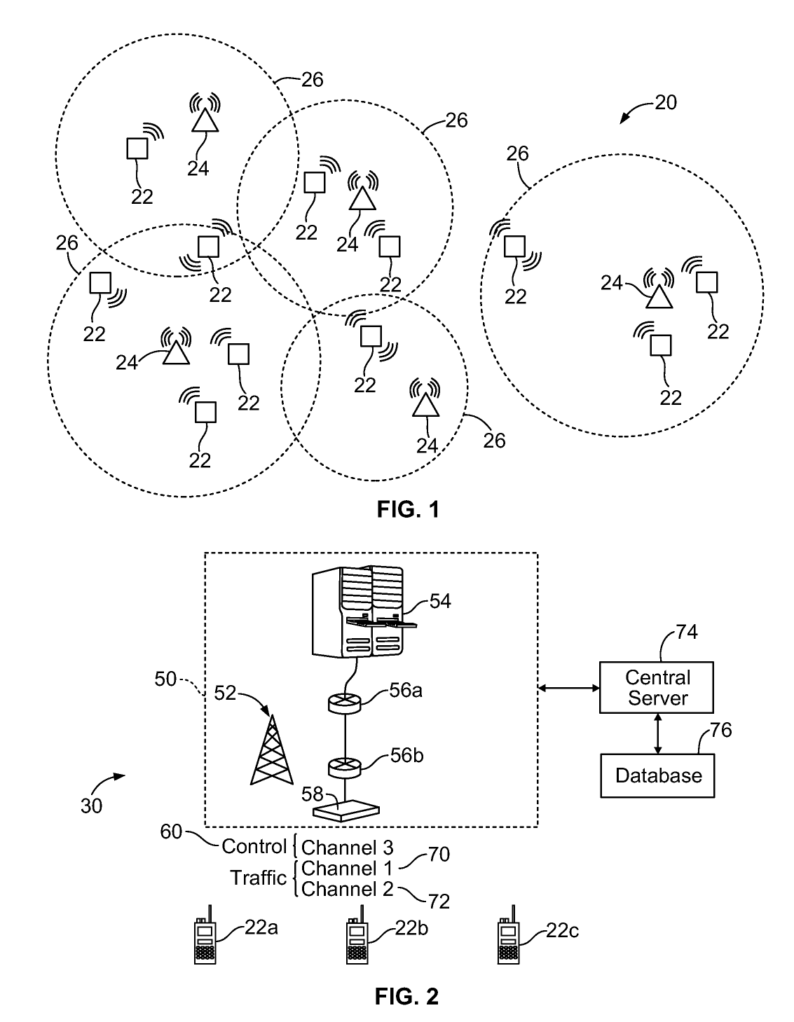

As shown in FIG. 1, a wireless communication system 20, for example, a professional communication system constructed according to various embodiments of the invention provides dynamic assignment of radio units 22 (or terminals), which may be configured for mobile operation, to one or more communication groups. It should be noted that when reference is made herein to a radio unit, this refers to any type of communication device capable of providing two-way or bi-directional communication. For example, the radio unit 22 may be a land mobile radio (LMR) or a cellular telephone having push-to-talk (PTT) capabilities. However, the radio units 22 also may be fixed units, such as dispatch consoles or may be other types of mobile units, such as, handheld units. Communication between the radio units 22 may be provided, for example, via an EDGE network having a communication coverage area defined by a plurality of communication base stations 24 and associated communication towers. Within the communication coverage area, Radio Frequency (RF) coverage is provided by each of the base stations 24 and defines a plurality of communication cells 26. The communication cells 26 may or may not overlap.

Additionally, the radio units 22 may communicate directly with each other or with a group of radio units 22 that is dynamically defined in accordance with various embodiments of the invention. For example, the radio units 22 may be dynamically registered with one or more talk groups or workgroups such that the radio units 22 receive communications from different groups or sub-groups of other radio units 22, respectively, based on predetermined rules and attributes of the users associated with each of the radio units 22.

In various embodiments, a plurality of radio units 22, for example, radio units 22a and 22b may be configured to communicate on a radio network 30 (e.g., trunked radio network) wherein group communications are provided on shared communication channels as shown in FIG. 2. The radio units 22a and 22b may also communicate with other radio units, for example, the radio unit 22c, as well as a dispatch unit (not shown). The radio network 30 includes a plurality of site controllers 50 (only one site controller 50 is shown for ease of explanation) that controls communications at one or more communication towers 52. The site controller 50 includes a processor 54, for example, a server that is connected to one or more routers 56a and 56b. The one or more routers 56a and 56b are connected to a communication controller 58 that controls communications to and from the radio units 22a-22c.

Call control and signaling information is provided by the communication controller 58 and may include, for example, a control stream of transmitted data that identifies or notifies radio units 22 within the range of the communication tower 52 of all the active calls, such as, all the ongoing open communications, as well as, for example, group assignment information, priority information relating to the priority of incoming and outgoing calls, timing information, frequency information, channel information, etc. For example, the communication controller 58 uses a control channel 60 to identify talk groups, for example, a first talk group (TG1), such as a police department talk group, that is communicating on a first traffic channel 70 (e.g., channel 1) and a second talk group (TG2), such as another police department talk group (e.g., from a different municipality) or a fire department talk group, that is communicating on a second traffic channel 72 (e.g., channel 2). Essentially, a talk group, workgroup or other communication group communicates using a single channel through the communication tower 52. The radio units 20 are dynamically assigned to one or more talk groups or workgroups. Each active group communication may communicate using one or more traffic channels assigned to the one or more talk groups, workgroups, etc. to which that radio unit 20 is currently registered.

Thus, the communication controller 58 is assigned a channel for communicating with the routers 56a and 56b to provide inbound signaling from subscribers, namely radio units 20. The communication controller 58 is also assigned a control channel 60 that relays the control information to the radio units 20. The communication controller 58 also provides a plurality of traffic channels 70 and 72 that allow shared communication between radio units 20, for example, in a talk group. It should be noted that the traffic channels 70 and 72 may be assigned to the communication controller 58 from a central location and stored in a memory or alternatively assigned directly by the communication controller 58.

The site controller 50 also may communicate with a central server 74. The central server 74 provides centrally administered talk group or workgroup creation for radio units 20 within one or more communication cells. Alternatively, each site controller 50 may provide such centralized administration with a single communication cell. The central server 74 is connected to a database 76 that stores attributes (or credentials) for each radio unit 20, and in particular, for each user associated with each radio unit 20. Additionally, the database 76 stores rules for particular talk groups or workgroups that define the particular attributes that are required or optional for that talk group or workgroup.

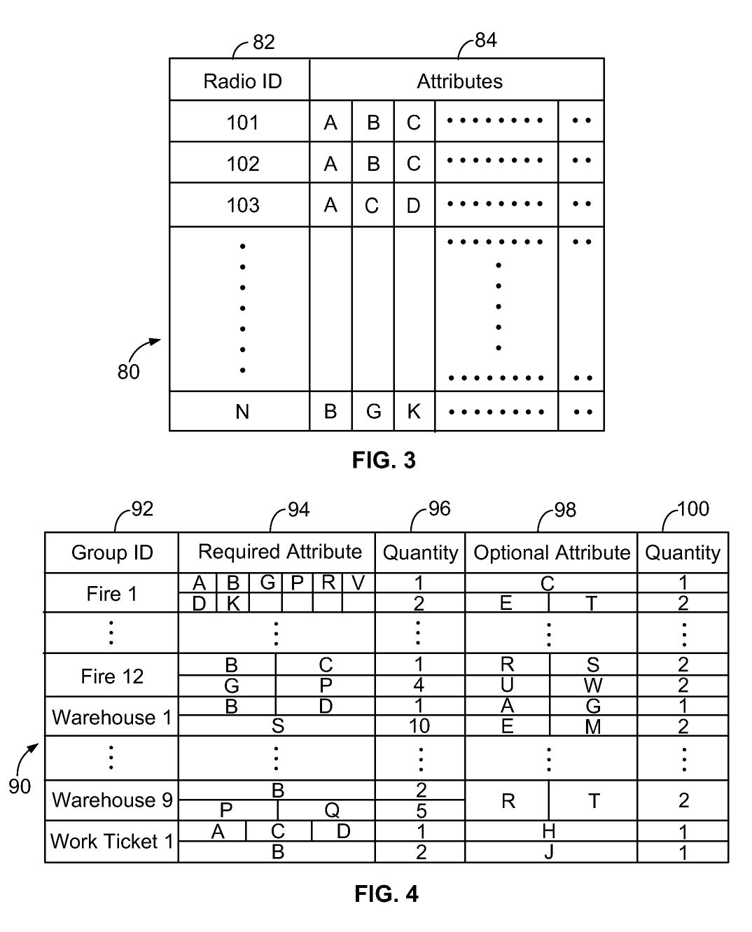

For example, as shown in the chart 80 of FIG. 3, which represents data that may be stored in the database 76 (shown in FIG. 2), the stored data may include information that identifies for each radio unit 20, attributes associated therewith. It should be noted that the arrangement, order and format of the data may be provided in any manner, for example, at a plurality of different memory locations or addresses that may or may nor be consecutive. As illustrated, the chart 80 includes a radio identification (Radio ID) column 82 and an Attributes column 84. The Radio ID column 82 includes a list of each of a plurality of radio units 20 (which may be all radio units 20 in a particular communication system or associated with a particular entity) and the Attributes column 84 includes the attributes associated with or corresponding to each of the radio units 20 in the Radio ID column 82. The attributes 84 may be identified by a code, for example, a letter code. The attributes can include any identifying qualities, qualifications or credentials for a user associated with each of the radio units 20. For example, the attributes may define one or more positions the user has in an organization (e.g., supervisor), one or more skills (e.g., knowledge of hazardous materials or carpenter) of the user, etc. Accordingly, for the user for each radio unit 20, the attributes identify the role(s) that the user can satisfy or fulfill for a particular situation or event (e.g., emergency fire condition) or application (e.g., construction site project).

It should be noted that the attributes are not limited to attributes associated with users of radio units 20. For example, stored attributes may be associated with a piece of equipment, such as specifications for a piece of equipment. For example, the attributes may be associated with a piece of emergency equipment, such as a fire truck. The fire truck in various embodiments includes a vehicle mounted radio unit. Accordingly, the attributes for the fire truck may identify the type of fire truck (e.g., pumper, foamer, ladder truck, etc.), the capabilities of the fire truck (e.g., water storage capacity), the size of the fire truck, etc. As another example, such as in a construction work group, the attributes may be associated with pieces of equipment, such as bulldozers, graders, etc, and the capabilities thereof.

It also should be noted that a radio unit 20 may be associated with a particular user based on, for example, a user logging in with a specific User ID corresponding to that user. Accordingly, at different times a radio unit 20 may be associated with different users having different attributes. Alternatively, a particular radio unit 20 may be continually associated with a single user.

With respect to the rules, a plurality of predetermined or predefined system rules are provided that specify the required or optional attributes for each talk group or workgroup. The system rules are then used to dynamically define the members (users or radio units 20) for the talk group or workgroup, which may be based on certain trigger events. For example, as shown in FIG. 4, a table 90 representing data stored in the database 76 (shown in FIG. 2) includes rules for each of a plurality of talk groups or workgroups. It should be noted that the talk group or workgroup may be an ongoing group (e.g., group at an industrial facility) or a group that is limited in time (e.g., group performing a construction project). The chart 90 includes a Group ID column 92 that identifies a plurality of different groups. The groups may be related or unrelated. A Required Attribute column 94 identifies the attributes required for each of the corresponding groups in the Group ID column 92. For each group, one or more attributes are predefined or predetermined including the quantity needed of each attribute, which is identified in a corresponding Quantity column 96. Accordingly, for each group identified in the Group ID column 92, a predetermined number of required attributes is predefined by the Required Attribute column 94 and the Quantity column 96. When reference is made herein to required attributes, this refers to attributes that must be present within a particular talk group or workgroup. Accordingly, radio units 20 with users satisfying these attributes that are, for example, within a communication range of an event, must be assigned to the talk group or workgroup. The radio units 20 are assigned to the talk group or workgroup based on the attributes for the radio units 20. Thus, a user may be placed into a group call regardless of whether the user desires joining the group call.

The chart 90 also similarly may define a predetermined number of optional attributes for each group as identified in an Optional Attribute column 98 and Quantity column 100. When reference is made herein to optional attributes, this refers to attributes that do not necessarily have to be present within a particular talk group or workgroup, but may be desired (e.g., extra workers on a construction site having a particular skill set).

It should be noted that the attributes may be stored centrally, for example, in the database 76 (shown in FIG. 2). Optionally, or additionally, the attributes may be stored in each corresponding radio unit 20.

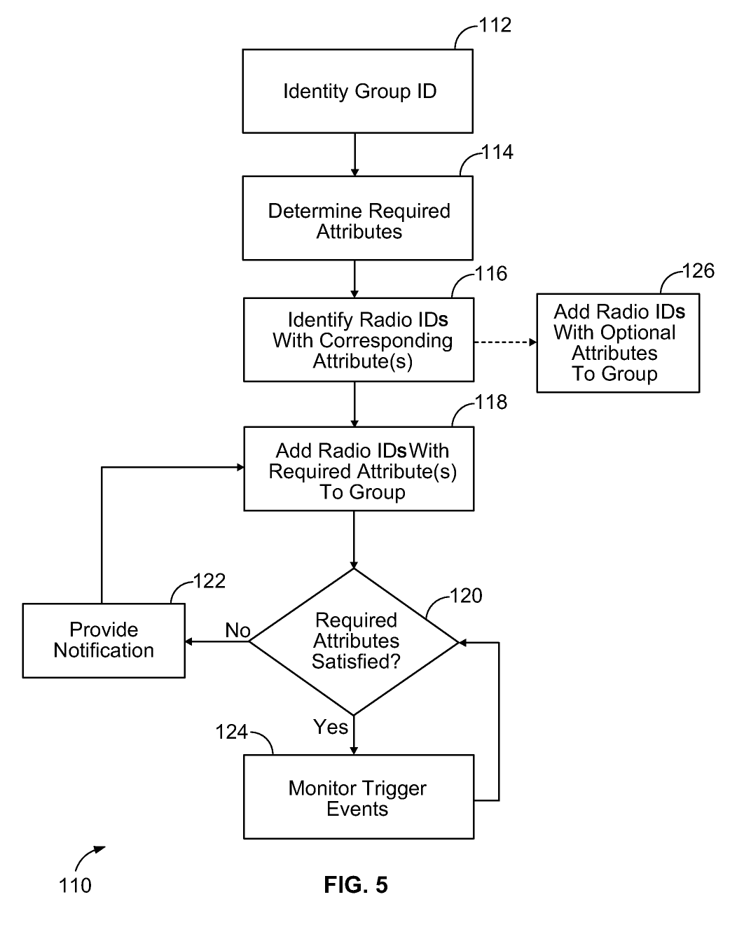

Using the stored attributes and system rules, dynamic group assignment is provided. Specifically, in accordance with various embodiments of the invention, a method 110 for dynamically creating talk groups or workgroups is shown in FIG. 5. The method 110 includes identifying at 112 one or more groups, for example, using a Group ID. The groups may be any type of group, for example, a commercial group of users, such as at an industrial facility, an emergency group of user, such as a police or fire department group, a project based group of users, such as defined by a work ticket, a personal group of users, etc. The groups may be identified at any time as desired or needed. For example, a dispatcher may initiate or activate action based on an event (e.g., fire emergency) or the group may be one that is continuously active, such as at an industrial facility having different shifts.

For an identified group, required attributes are then determined at 114. For example, for the group, the required number of users having particular attributes is determined, which may be stored in a central database. The determination at 114 results in a list of attributes (and the quantity for each) that must be included in the talk group or workgroup. Accordingly, a minimum set of users for the group is defined by the required attributes. Thus, the identified group must meet these minimum criteria and include the requisite number and types of attributes. Once the type and quantity of each attribute is determined, radio units satisfying the required attributes are identified at 116. For example, Radio IDs in the central database corresponding to each of the required attributes are identified. The resulting list of Radio IDs includes both active and non-active radio units. In various embodiments, the identified Radio IDs at 116 includes every Radio ID in the database that includes any one of the required attributes. It should be noted that some Radio IDs may be associated with more than one of the required attributes. In such a case, the attributes may be, for example, prioritized, such that the Radio ID is identified only for the highest priority attribute.

It should be noted that in some embodiments, in order to manage bandwidth usage, the size of the group may be limited. For example, the group may be limited to users that have the best attributes or highest qualifications.

Once the Radio IDs have been identified, dynamic assignment of Radio IDs to the group is initiated. In particular, at 118 the identified Radio IDs with the required attributes are added to the group. For example, Radio IDs corresponding to active radio units are added to the group and connected to the group call. Active radio unit in some embodiments includes radio units that are not only logged in, but also are determined to be within a certain geographic location. For example, the geographic criteria may be based on the communication cell in which the radio unit is communicating. The determination of the communication cell in which the radio unit is located may be performed using any known method, for example, using ping messages, triangulation from multiple towers for more accurate location determination, etc. Optionally, the radio units may include a GPS unit enabling determination of the location of the radio units.

As the radio units are added to the group, a determination is made at 120 as to whether all the required attributes (including the required numbers) are satisfied. For example, a determination is made as to whether each of the required number of attributes is satisfied by a corresponding radio unit added to the group. If a determination is made at 120 that the added radio units do not satisfy the required attributes, thereby failing to fulfill the minimum requirements or criteria for the group, a notification may be provided at 122. For example, a visual or audio alarm may be provided, such as at a dispatch location or on one or more of the radio units. The notification may indicate the required attributes that are missing. Thereafter, manual methods, for example, dispatcher calls, may be used to locate additional radio units to satisfy the missing attributes. Once a radio unit is identified that satisfies one of the missing attributes, the Radio ID for that radio unit is added to the group at 118 and that radio unit registered with the group.

If at 120 a determination is made that all the required attributes are satisfied, trigger events are monitored at 124. For example, the trigger events may include a radio unit logging in or logging out, a change in state or location of a radio unit, etc. As the trigger events are monitored, periodic or constant determinations of whether the required attributes are still satisfied at 120 are performed. Accordingly, as radios become inactive (e.g., logged off or geographically removed) and additional radios become active, the method 110 dynamically assigns radios to the group to satisfy the required attributes such as by adding or removing Radio IDs from the group.

It should be noted that in addition to required attributes, the method 110 may also determine whether optional attributes should be added to the group. If optional attributes are desired to be added, Radio IDs having the optional attributes are added to the group at 126 and dynamic group assignment is performed as described above.

When reference is made here to dynamic groups, this can refer to the dynamic maintenance of a group and/or the dynamic creation of a group. For example, the dynamic maintenance of a group refers to maintaining group members over time such that the required (and optional attributes) for that group are satisfied. Accordingly, group members may be added and removed, for example, as shifts change in a manufacturing facility. Dynamic creation of a group can include, for example, creating a group for a single purpose, such as based on a work ticket. The group can be created at any time and exists only as long as the project is open. Once the project is complete and the ticket is closed, the group ceases to exist. For example, a work ticket may be created for repair to a power line that requires an expert in a particular type of transformer, a linesman, a lift operator, etc. The various embodiments then add group members to fulfill the required attributes (and optional attributes where applicable). Once the power line repair is complete, the group is canceled and ceases to exist.

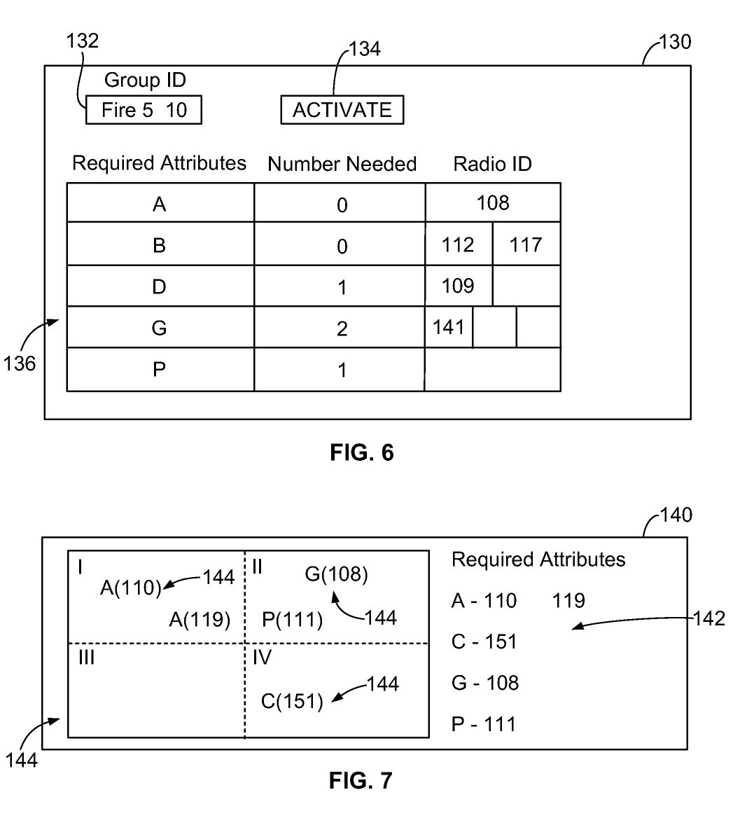

Various embodiments of the invention also may provide an interface, for example, displayed on a console at a dispatch station or company main office, or on a radio unit. For example, as shown in FIG. 6, an interface 130 may be provided that displays dynamic group assignment information. In particular, the interface includes a Group ID field 132 from which a group (e.g., Group ID stored in the central database) may be selected, such as from a drop-down menu. Alternatively, if the Group ID is known, the Group ID may be typed into the Group ID field 132.

The interface 130 may also include an Activate member 134, which is selectable. The selection of the Activate member 134 may, for example, initiate dynamic assignment of the group members for the selected Group ID, which are assigned as described in more detail herein. The Activate member 134 also may be used to initiate activation of an electronic ticket or work order having certain minimum attributes, which then commences the method 110 (shown in FIG. 5).

The interface 130 also includes a status portion 136 that is populated with the required attributes based on the selected Group ID in the Group ID field 132. The status portion 136 displays the number of radio units still needed to satisfy the required attributes and the Radio IDs for the radio units that have been added to the group as satisfying one of the attributes. The status portion 136 is updated as radio units are registered and connected to the group. If the required attributes are not satisfied, for example, after a predetermined time period (e.g., five minutes), notification may be provided as described herein. Alternatively, blank Radio ID fields are displayed in connection with the number of radio units still needed.

Various embodiments of the invention also may include an interface 140 as shown in FIG. 7. The interface 140 make include a status portion 142, similar to the status portion 136 of the interface 130. Additionally, the interface 140 includes a locator portion 142 that displays the current or relative locations of radio units added to the group and currently active. The locator portion 142 may be divided, for example, into quadrants. The locator portion 142 includes identifiers 144 that identify the active radio units in the group and the attribute that the radio unit satisfies. Accordingly, radio units in a group may be tracked.

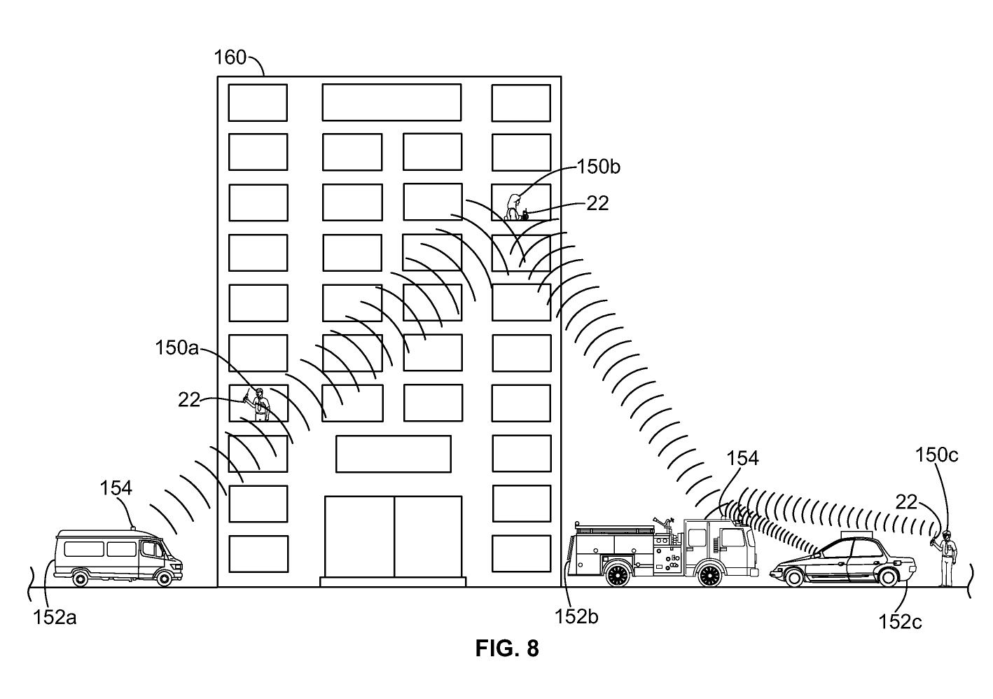

Thus, by dynamically assigning radio units to a group, the various embodiments automatically ensure that a required minimum number of individuals (e.g., radio users) having certain attributes are present, for example, at an incident that needs emergency personnel as shown in FIG. 8. In illustrated example, the various embodiments ensure that the requisite personnel are present at the incident by adding radio units satisfying the required attributes. Accordingly, a plurality of radio units 20 are present at the incident, which may include mobile radio units 22 associated with individuals 150a, 150b and 150c (that may be located on different floors of a building 160) or with vehicles 152a, 152b and 152c. One or more the vehicles, for example, vehicles 152a and 152b may include vehicle repeaters 154 as is known. The various embodiments of the invention ensure that the required individuals (and vehicles) are present at the building 160 to respond to the incident by dynamically assigning Radio IDs based on predefines rules for the type of incident.

As another example, the various embodiments may be implemented in connection with a large industrial facility having multiple shifts. In this example, the facility has a firefighting group (Fire 1) with the members changing with each shift. The members of the group have different skills and play different roles, which may include different levels of the command chain, knowledge of hazardous materials or first aid, etc. As trigger events occur, for example, members logging in and out during shift changes, the various embodiments add and remove radio units corresponding to the members to satisfy the attributes (fill the roles) for the group as defined by the rules for the group. For example, in one embodiment, Fire 1 must include a commander, everyone with firefighting and first aid attributes (skills), and all members must be within one mile of the facility (to be close enough to fight a fire). Any communications on the channel assigned to Fire 1 includes only radio units for the members that satisfy these group rules. As described in more detail herein, a notification or alarm can be provided if the requisite number of members to satisfy the minimum attributes are not present. It should be noted that the group rules can change based on certain conditions to increase or decrease the group dynamically. For example, if a facility wide emergency is declared, the group can be increased to include all off duty personnel having fire fighting attributes (credentials). As another example, if a minor incident occurs requiring only member with first aid attributes (credentials), then the group can be decreased to include just first aid attributes. It should be noted that one or more the members of the group may be communicating via a wired connection, wireless connection, Internet based connection, etc. For example, a sheriff or fire chief may connect from a home computer using a client running on a computer or from a home land line. As another example, a plurality of police or fire chiefs may participate using an Internet based group call.

Thus, the various embodiments of the invention allow quick and easy creation or modification of talk groups or workgroups. The groups are defined based on attributes and rules required for the situation, application, event, etc. The various embodiments then dynamically assign or adds/removes the radio units needed for the talk group or workgroup.

The various embodiments or components, for example, the communication systems, networks or controllers therein, may be implemented as part of one or more computer systems. The computer system may include a computer, an input device, a display unit and an interface, for example, for accessing the Internet. The computer may include a microprocessor. The microprocessor may be connected to a communication bus. The computer may also include a memory. The memory may include Random Access Memory (RAM) and Read Only Memory (ROM). The computer system further may include a storage device, which may be a hard disk drive or a removable storage drive such as a floppy disk drive, optical disk drive, and the like. The storage device may also be other similar means for loading computer programs or other instructions into the computer system.

As used herein, the term “computer” may include any processor-based or microprocessor-based system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer system executes a set of instructions that are stored in one or more storage elements, in order to process input data. The storage elements may also store data or other information as desired or needed. The storage element may be in the form of an information source or a physical memory element within the processing machine.

The set of instructions may include various commands that instruct the computer as a processing machine to perform specific operations such as the methods and processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. For example, the ordering of steps recited in a method need not be performed in a particular order unless explicitly stated or implicitly required (e.g., one step requires the results or a product of a previous step to be available). While the dimensions and types of materials described herein are intended to define the parameters of the invention, they are by no means limiting and are exemplary embodiments. Many other embodiments will be apparent to those of skill in the art upon reviewing and understanding the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for creating a communication group for wireless communication, the method comprising:
associating attributes with a plurality of radio units;
defining a communication group based on the attributes, the communication group having a plurality of required attributes establishing minimum criteria for the communication group; and
dynamically maintaining the communication group with radio units that satisfy the required attributes.

2. A method in accordance with claim 1 wherein dynamically maintaining the communication group comprises adding radio units to the communication group and further comprising determining whether the added radio units fulfill the minimum criteria.

3. A method in accordance with claim 2 further comprising providing notification if the minimum criteria is not fulfilled.

4. A method in accordance with claim 1 further comprising storing in a central database attributes associated with each of a plurality of radio units.

5. A method in accordance with claim 1 further comprising storing in each of a plurality of radio units attributes associated with the radio units.

6. A method in accordance with claim 1 wherein dynamically maintaining the communication group comprises adding radio units to the communication group based on a trigger event.

7. A method in accordance -with claim 6 wherein the trigger event comprises at least one of a logging in of a radio unit, a logging out of a radio unit, a change in state of a radio unit and a change in location of radio unit.

8. A method in accordance with claim 1 wherein dynamically maintaining the communication group comprises dynamically adding to the communication group radio units within a range of a determined location.

9. A method in accordance with claim 1 further comprising storing the required attributes in a central database.

10. A method in accordance with claim 1 wherein the attributes comprise skills of users associated with the radio units.

11. A method in accordance with claim 1 wherein the attributes comprise specifications of a piece of equipment.

12. A method in accordance with claim 1 wherein the required attributes are defined based on an electronic work ticket.

13. A method in accordance with claim 1 wherein the required attributes are defined based on predetermined rules.

14. A method in accordance with claim 1 further comprising displaying a status of the required attributes.

15. A method for dynamically creating a communication group, the method comprising:
accessing a central database having stored therein attributes associated with a plurality of radio units;
determining rules for a communication group;
identifying radio units with attributes that satisfy the rules for the communication group; and
adding the identified radio units to the communication group, the added radio units connected to a group call.

16. A method in accordance with claim 15 further comprising determining whether a minimum set of attributes are fulfilled and providing notification when the minimum set of attributes are not fulfilled.

17. A method in accordance with claim 15 wherein adding the identified radio units to the communication group is automatic.

18. A method in accordance with claim 15 wherein the rules for the communication group are fixed.

19. A method in accordance with claim 15 wherein the rules for the communication group are changeable.

20. A communication system comprising:
a plurality of radio units configured to communicate via group calls;
a database storing attributes associated with each of the plurality of radio units;
a processor configured to process rules to determine a set of attributes for a communication group; and
a controller configured to dynamically maintain the communication group to include radio units from the plurality of radio units that satisfy a minimum set of attributes.
